(19) United States
(12) Patent Application Publication
(10) Pub. No.: US 2020/0130997 A1
(43) Pub. Date: Apr. 30, 2020

(54) ELEVATOR SERVICE REQUEST USING USER DEVICE WITH FILTERED DESTINATION FLOOR SELECTION

(71) Applicant: Otis Elevator Company, Farmington, CT (US)

(72) Inventor: Paul A. Simcik, Southington, CT (US)

(21) Appl. No.: 16/455,019

(22) Filed: Jun. 27, 2019

Related U.S. Application Data
(60) Provisional application No. 62/751,099, filed on Oct. 26, 2018.

(51) Int. Cl. B66B 3/00; B66B 1/46

(52) U.S. Cl. CPC B66B 3/006; B66B 1/468; B66B 2201/4676; B66B 2201/4653; B66B 2201/20; B66B 2201/4615

(57) ABSTRACT

Methods and systems for providing and selecting multiple elevator assignments in a destination dispatching system. The method includes obtaining and presenting a primary elevator car assignment associated with a destination request, obtaining and presenting a secondary potential elevator car assignment associated with the destination request, and receiving information associated with a user selection related to at least one of the primary elevator car assignment and secondary potential elevator car assignment. The method also includes requesting, by the user device, a modification of the primary elevator car assignment if the information associated with a user selection indicates a modification is desired by the user; otherwise, continuing with the primary elevator car assignment.

### CROSS-REFERENCE TO RELATED APPLICATIONS

This application claims the benefit of U.S. Provisional Application 62/751,099 filed Oct. 26, 2018, which is incorporated herein by reference in its entirety.

### BACKGROUND

The subject matter disclosed herein generally relates to service requests for elevators and, more particularly, to elevator service requests using user devices.

Elevator systems can receive input from users through mechanical, electrical, and/or electromechanical devices located within or as part of the elevator system. That is, requests for elevator service are typically made by potential passengers when the passenger is already located at an elevator landing. However, having a remote mechanism to make such requests may be advantageous. For example, the use of personal user devices can enable remote elevator service requests, potentially improving user experience and/or enabling improved elevator management within a building.

Passengers using elevators can generally give calls to elevators either in an elevator car and/or in an elevator lobby. Elevator lobbies are typically provided with up/down pushbuttons, by means of which a passenger can order an elevator to the call floor and simultaneously indicate his/her travel direction. After the elevator has arrived at the call-giving floor, the passenger moves into the elevator car and indicates his/her destination floor with the pushbuttons of the car panel in the elevator car. When the call-giving device is portable, or when the system does not otherwise know from which floor a call comes, a destination call may need to include information about the departure floor. After it has received a destination call the control system of the elevator system allocates the optimal elevator for the use of the passenger and transmits information about this to the call-giving device. In this way, the elevator system identifies to the user in response to a destination call the elevator allocated to him/her.

In some instances, it is possible that one or more elevator cars could be a possible alternative to the optimal assigned car. It is also possible that the assigned car is delayed or full and becomes less desirable. In addition, if a user sees that other cars are arriving before the assigned car, the passenger may become disgruntled or annoyed with having to wait what appears to be longer than the optimal time. Displaying the arrival time of the car may alleviate some of the concern, nonetheless, there may be instances where it may be advantageous for the passenger to travel via a secondary car, rather than that originally assigned.

What would be advantageous would be a scheme of identifying displaying the assigned car as well as an alternative and permitting a passenger to elect the alternative under selected condition.

### BRIEF SUMMARY

According to one embodiment, described herein is a method and systems for providing and selecting multiple elevator assignments in a destination dispatching system. The method includes obtaining and presenting a primary elevator car assignment associated with a destination request, obtaining and presenting a secondary potential elevator car assignment associated with the destination request, and receiving information associated with a user selection related to at least one of the primary elevator car assignment and secondary potential elevator car assignment. The method also includes requesting, by the user device, a modification of the primary elevator car assignment if the information associated with a user selection indicates a modification is desired by the user; otherwise, continuing with the primary elevator car assignment and obtaining.

In addition to one or more of the features described herein, or as alternatives, further embodiments of the methods may include presenting a revised primary elevator car assignment associated with a the requesting.

In addition to one or more of the features described herein, or as alternatives, further embodiments of the methods may include that the primary elevator car assignment is the first, most optimal, elevator car assignment by the destination dispatching system.

In addition to one or more of the features described herein, or as alternatives, further embodiments of the methods may include that the user device includes a graphical object associated with the primary elevator car assignment and a graphical object associated with the secondary potential elevator car assignment.

In addition to one or more of the features described herein, or as alternatives, further embodiments of the methods may include that the receiving information includes a selection of at least one of the graphical object associated with primary elevator car assignment, the graphical object associated with the secondary potential elevator car assignment, and a user action.

In addition to one or more of the features described herein, or as alternatives, further embodiments of the methods may include that the user action includes at least one of the user entering the elevator car associated with the primary elevator car assignment and the user entering the elevator car associated with the secondary potential elevator car assignment.

In addition to one or more of the features described herein, or as alternatives, further embodiments of the methods may include that the receiving further includes detecting a presence of the user device in at least one of the elevator car associated with the primary elevator car assignment and the user device entering the elevator car associated with the secondary potential elevator car assignment, the detecting based on communicating from the user device to at least one of the elevator car associated with the primary elevator car assignment and the elevator car associated with the secondary potential elevator car assignment or communicating to the user device in at least one of the elevator car associated with the primary elevator car assignment and the user device entering the elevator car associated with the secondary potential elevator car assignment, the communicating associated with indicating to the user device that the user has entered the at least one of the elevator car associated with the primary elevator car assignment and the elevator car associated with the secondary potential elevator car assignment.

In addition to one or more of the features described herein, or as alternatives, further embodiments of the methods may include that the selection of at least one of the graphical object associated with a primary elevator car assignment, the graphical object associated with the secondary potential elevator car assignment includes any of a press on the graphical object associated with a primary elevator car assignment, a press on the graphical object associated with a secondary elevator car assignment, a swipe input from the graphical object icon for the secondary potential elevator car assignment to the graphical object for the primary elevator car assignment or a press and drag to and drop of the graphical object icon for the secondary potential elevator car assignment to the graphical object for the primary elevator car assignment.

In addition to one or more of the features described herein, or as alternatives, further embodiments of the methods may include that the requesting a modification includes communicating by the user device a request to modify the primary elevator car assignment to an elevator controller.

In addition to one or more of the features described herein, or as alternatives, further embodiments of the methods may include presenting, by a user device, a primary elevator car assignment includes displaying a graphical object associated with the primary elevator car assignment, or presenting, by a user device, a secondary potential elevator car assignment includes displaying a graphical object associated with the second elevator car assignment, or presenting, by a user device, a revised primary elevator car assignment associated with the requesting includes displaying a graphical object associated with the revised primary elevator car assignment.

In addition to one or more of the features described herein, or as alternatives, further embodiments of the methods may include that the displaying the graphical object associated with the primary elevator car assignment includes at least one of a displaying the graphical icon as at least one of larger, bolder, highlighted, in a different color, and flashing when compared to the graphical icon associated with the secondary potential elevator car assignment.

In addition to one or more of the features described herein, or as alternatives, further embodiments of the methods may include that the displaying the graphical object associated with the revised primary elevator car assignment includes at least one of a displaying the graphical icon as at least one of larger, bolder, highlighted, in a different color, and flashing when compared to the graphical icon associated with the secondary potential elevator car assignment.

In addition to one or more of the features described herein, or as alternatives, further embodiments of the methods may include that the displaying the graphical object associated with the secondary potential elevator car assignment includes at least one of a displaying the graphical icon as at least one of smaller, lighter, shadowed, in a different color, and changing when compared to the graphical icon associated with the primary elevator car assignment.

In addition to one or more of the features described herein, or as alternatives, further embodiments of the methods may include that the changing includes at least one of changing size, changing shape, changing boldness, changing color.

In addition to one or more of the features described herein, or as alternatives, further embodiments of the methods may include that the changing is based on the favorability of the secondary potential elevator car assignment to the user.

In addition to one or more of the features described herein, or as alternatives, further embodiments of the methods may include that the favorability to the user is based at least in part on arrival time of the elevator car associated with the secondary potential elevator car assignment.

Also described herein in another embodiment is a user device for making elevator service requests, the user device includes at least one processor, a display, and memory having instructions stored thereon that, when executed by the at least one processor, cause the user device to obtain and present a primary elevator car assignment associated with a destination request obtain and present a secondary potential elevator car assignment associated with the destination request, and to receive information associated with a user selection related to at least one of the primary elevator car assignment and secondary potential elevator car assignment. The instructions also cause the user device to request a modification of the primary elevator car assignment if the information associated with a user selection indicates a modification is desired by the user; otherwise, continuing with the primary elevator car assignment.

In addition to one or more of the features described herein, or as alternatives, further embodiments of the user device may include presenting a revised primary elevator car assignment associated with a the requesting.

In addition to one or more of the features described herein, or as alternatives, further embodiments of the user device may include that the primary elevator car assignment is the first, most optimal, elevator car assignment by the destination dispatching system.

In addition to one or more of the features described herein, or as alternatives, further embodiments of the user device may include that the user device includes a screen with a graphical object associated with the primary elevator car assignment and a graphical object associated with the secondary potential elevator car assignment.

In addition to one or more of the features described herein, or as alternatives, further embodiments of the user device may include that the receiving information includes a selection of at least one of the graphical object associated with primary elevator car assignment, the graphical object associated with the secondary potential elevator car assignment, and a user action.

In addition to one or more of the features described herein, or as alternatives, further embodiments of the methods user device may include that the user action includes at least one of the user entering the elevator car associated with the primary elevator car assignment and the user entering the elevator car associated with the secondary potential elevator car assignment.

In addition to one or more of the features described herein, or as alternatives, further embodiments of the user device may include that the receiving further includes detecting a presence of the user device in at least one of the elevator car associated with the primary elevator car assignment and the user device entering the elevator car associated with the secondary potential elevator car assignment, the detecting based on communicating from the user device to at least one of the elevator car associated with the primary elevator car assignment and the elevator car associated with the secondary potential elevator car assignment, or, communicating to the user device in at least one of the elevator car associated with the primary elevator car assignment and the user device entering the elevator car associated with the secondary potential elevator car assignment, the communicating associated with indicating to the user device that the user has entered the at least one of the elevator car associated with the primary elevator car assignment and the elevator car associated with the secondary potential elevator car assignment.

In addition to one or more of the features described herein, or as alternatives, further embodiments of the user device may include that the selection of at least one of the graphical object associated with a primary elevator car assignment, the graphical object associated with the secondary potential elevator car assignment includes any of a press on the graphical object associated with a primary elevator car assignment, a press on the graphical object associated with a secondary elevator car assignment, a swipe input from the graphical object icon for the secondary potential elevator car assignment to the graphical object for the primary elevator car assignment; or a press and drag to and drop of the graphical object icon for the secondary potential elevator car assignment to the graphical object for the primary elevator car assignment.

In addition to one or more of the features described herein, or as alternatives, further embodiments of the user device may include that the requesting a modification includes communicating by the user device a request to modify the primary elevator car assignment to an elevator controller.

In addition to one or more of the features described herein, or as alternatives, further embodiments of the user device may include that presenting a primary elevator car assignment includes displaying a graphical object associated with the primary elevator car assignment, or presenting a secondary potential elevator car assignment includes displaying a graphical object associated with the second elevator car assignment, presenting a revised primary elevator car assignment associated with the requesting includes displaying a graphical object associated with the revised primary elevator car assignment.

In addition to one or more of the features described herein, or as alternatives, further embodiments of the user device may include that the displaying the graphical object associated with the primary elevator car assignment includes at least one of a displaying the graphical icon as at least one of larger, bolder, highlighted, in a different color, and flashing when compared to the graphical icon associated with the secondary potential elevator car assignment.

In addition to one or more of the features described herein, or as alternatives, further embodiments of the user device may include that the displaying the graphical object associated with the revised primary elevator car assignment includes at least one of a displaying the graphical icon as at least one of larger, bolder, highlighted, in a different color, and flashing when compared to the graphical icon associated with the secondary potential elevator car assignment.

In addition to one or more of the features described herein, or as alternatives, further embodiments of the user device may include that the displaying the graphical object associated with the secondary potential elevator car assignment includes at least one of a displaying the graphical icon as at least one of smaller, lighter, shadowed, in a different color, and changing when compared to the graphical icon associated with the primary elevator car assignment.

In addition to one or more of the features described herein, or as alternatives, further embodiments of the methods may include that the changing includes at least one of changing size, changing shape, changing boldness, changing color.

In addition to one or more of the features described herein, or as alternatives, further embodiments of the user device may include that the changing is based on the favorability of the secondary potential elevator car assignment to the user.

In addition to one or more of the features described herein, or as alternatives, further embodiments of the user device may include that the favorability to the user is based at least in part on arrival time of the elevator car associated with the secondary potential elevator car assignment.

In addition to one or more of the features described herein, or as alternatives, further embodiments of the user device may include that the computing device is a smartphone.

Technical effects of embodiments of the present disclosure include user devices and methods of operation configured to provide user interfaces and receive inputs thereon to generate and modify elevator service requests and assignments.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an example elevator system that may employ various embodiments of the present disclosure;

FIG. 2 is a schematic block diagram illustrating a system that may be configured in accordance with one or more embodiments of the present disclosure;

FIG. 3 is a schematic illustration of a system in accordance with an embodiment of the present disclosure;

FIG. 4A is a schematic illustration of a computing system of a user device in accordance with an embodiment of the present disclosure;

FIG. 4B is a schematic illustration of a computing system of an elevator controller in accordance with an embodiment of the present disclosure;

FIG. 5A is a schematic illustration of a user interface on a user device in accordance with an embodiment of the present disclosure;

FIG. 5B is another schematic illustration of the user interface in accordance with an embodiment of the present disclosure;

FIG. 5C is another schematic illustration of the user interface in accordance with an embodiment of the present disclosure; and

FIG. 6 illustrates a flow process for interacting with an elevator system in accordance with another embodiment of the present disclosure.

### DETAILED DESCRIPTION

In general the embodiment described herein relate to methods and systems for displaying an alternative car assignment to a passenger following a service request and assignment of a selected car in a destination dispatching system. In an embodiment, a user device is provided information regarding the assigned car as well as information regarding one or more alternative car assignments that may prove favorable. In an embodiment, the user may elect the alternative car assignment. If the alternative car is elected, the elevator system cancels the primary assignment and establishes the second or alternative assignment as the assignment for that passenger.

For the purposes of promoting and understanding of the principles of the present disclosure, reference will now be made to the embodiments illustrated in the drawings, and specific language will be used to describe the same. It will nevertheless be understood that no limitation of the scope of this disclosure is thereby intended. The following description is merely illustrative in nature and is not intended to limit the present disclosure, its application or uses. It should be understood that throughout the drawings, corresponding reference numerals indicate like or corresponding parts and features. As used herein, the term controller refers to processing circuitry that may include an application specific integrated circuit (ASIC), an electronic circuit, an electronic processor (shared, dedicated, or group) and memory that executes one or more software or firmware programs, a combinational logic circuit, and/or other suitable interfaces and components that provide the described functionality.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection”.

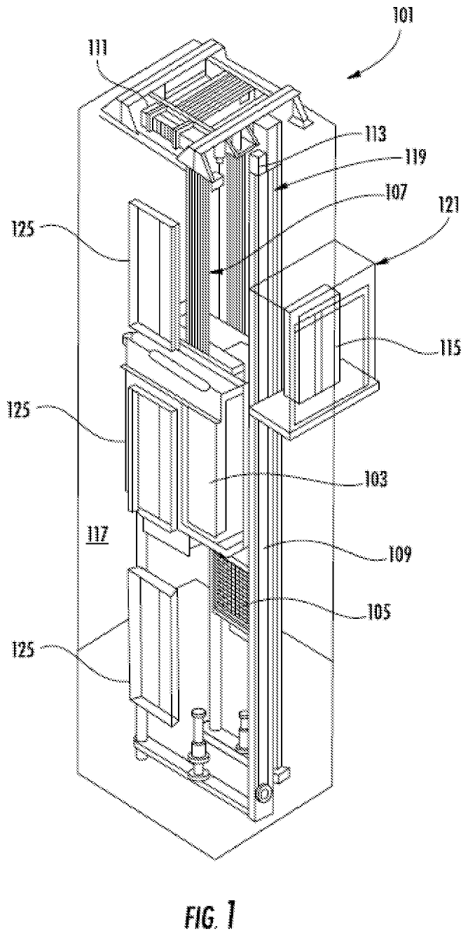

FIG. 1 is a perspective view of an elevator system 101 including an elevator car 103, a counterweight 105, a roping 107, a guide rail 109, a machine 111, a position encoder 113, and a controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which is part of an overhead structure of the elevator system 101. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position encoder 113. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor.

Although shown and described with a roping system, elevator systems that employ other methods and mechanisms of moving an elevator car within an elevator shaft, including but not limited to, hydraulic elevator systems, ropeless elevator systems, and/or elevator systems with more than one elevator car in each elevator shaft, may employ embodiments of the present disclosure. FIG. 1 is merely a non-limiting example presented for illustrative and explanatory purposes. It should be appreciated that any elevator system or system configuration may be employed.

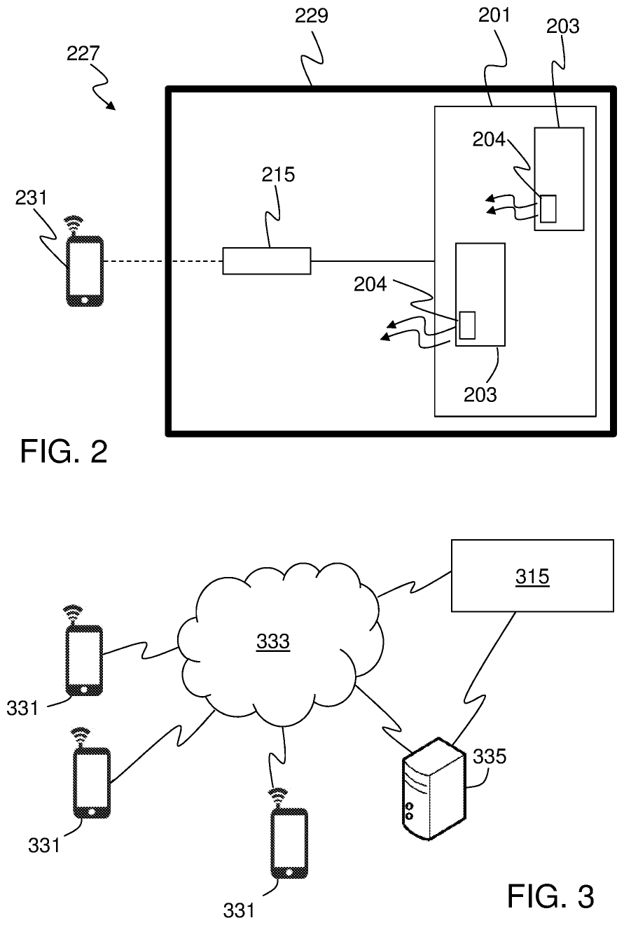

Turning now to FIG. 2, a schematic illustration of a building system 227 in an example embodiment of the present disclosure is shown. The building system 227 includes an elevator system 201 installed within a structure 229 (e.g., a building). In some embodiments, the structure 229 may be an office building or a collection of office buildings that may or may not be physically located near each other. The structure 229 may include any number of floors that are accessible by the elevator system 201 and thus the structure 229 can include any number of landings (e.g., as shown in FIG. 1). Persons entering the structure 229 may enter at a lobby floor, or any other desired floor, and may travel to a destination floor via one or more elevator cars 203 that are part of the elevator system 201.

The elevator system 201 may include one or more computing devices, such as an elevator controller 215. The elevator controller 215 may be configured to control dispatching operations for one or more elevator cars 203 associated with the elevator system 201. It is understood that the elevator system 201 may utilize more than one elevator controller 215, and that each elevator controller 215 may control a group of elevator cars 203 or individual elevator cars 203. Although two elevator cars 203 are shown in FIG. 2, those of skill in the art will appreciate that any number of elevators cars may be employed in the elevator and building systems that employ embodiments of the present disclosure. The elevator cars 203 can be located in the same hoistway or in different hoistways to allow coordination amongst elevator cars 203 in different elevator banks serving different floors (e.g., sky lobbies, etc.). It is understood that the elevator system 201 may include various features as described above with reference to FIG. 1 and may also include other non-depicted elements and/or features as known in the art (e.g., drive, counterweight, safeties, etc.). Moreover, the elevators may be employed in any configuration with all elevators serving all floors of the building, some elevators only serving certain floors, a first group of elevator serving lower floors of a building and a sky lobby and a second group of elevators serving the sky lobby and upper floors of the building, etc.

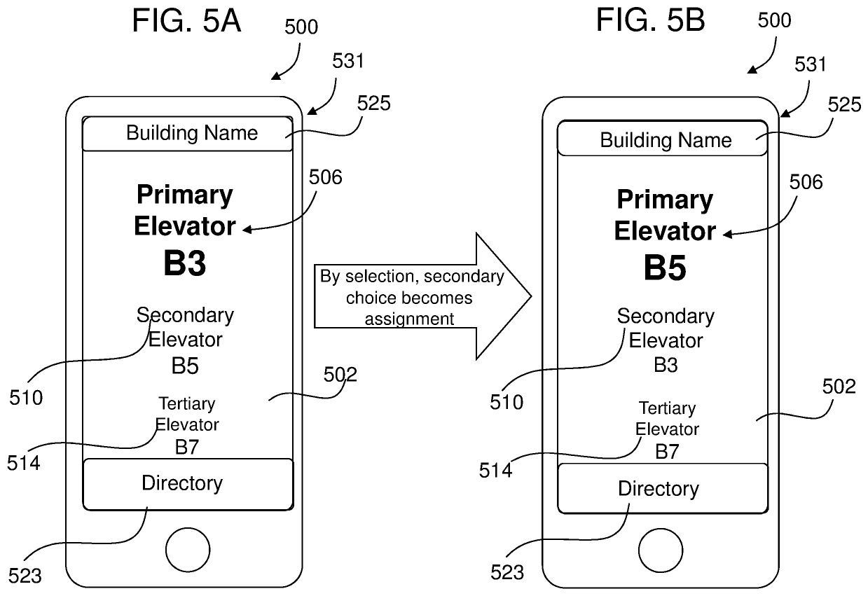

Also shown in FIG. 2 is a user device 231, such as a mobile device (e.g., smart phone, smart watch, wearable technology, laptop, tablet, etc.). The user device 231 may include a mobile and/or personal device that is typically carried by a person, such as a phone, PDA, tablet, smartwatch, laptop, etc. The user device 231 may include a processor 445a, memory 439a, and communication module(s) 449a, as shown in FIG. 4A. As described below, the processor can be any type or combination of computer processors, such as a microprocessor, microcontroller, digital signal processor, application specific integrated circuit, programmable logic device, and/or field programmable gate array. The memory can be a non-transitory computer readable storage medium tangibly embodied in the user device 231 including executable instructions stored therein, for instance, as firmware. The communication module may implement one or more communication protocols as described in further detail herein, and may include features to enable wireless communication with external and/or remote devices separate from the user device 231. The user device 231 may further include a user interface (e.g., a display screen, a microphone, speakers, input elements such as a keyboard or touch screen, etc.) as known in the art.

The elevator controller 215 may include a processor 445b, memory 439b, and a communication module 449b as shown in FIG. 4B. Similar to the user device 231, the processor memory, and communication module may be implemented as described above, but as part of the elevator system 201.

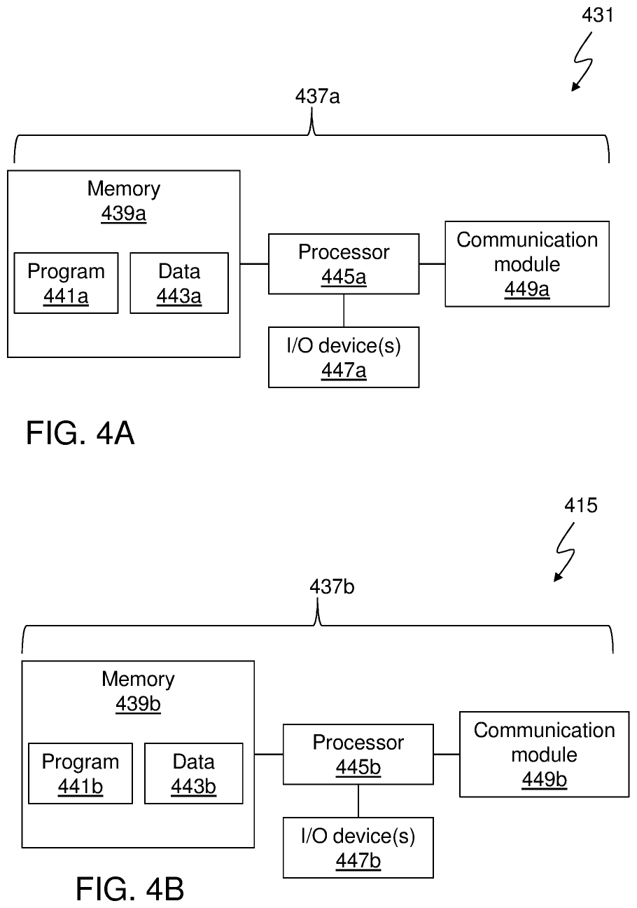

A user device 331 and an elevator controller 315 in accordance with embodiments of the present disclosure can communicate with one another, e.g., as shown in FIG. 3. For example, one or more user device 331 and the elevator controller 315 may communicate with one another when proximate to one another (e.g., within a threshold distance). The user device 331 and the elevator controller 315 may communicate over a network 333, that may be wired or wireless. Wireless communication networks can include, but are not limited to, Wi-Fi, short-range radio (e.g., Bluetooth®), near-field infrared, cellular network, etc. In some embodiments, the elevator controller 315 may include, or be associated with (e.g., communicatively coupled to) one or more networked building elements 335, such as computers, kiosks, beacons, hall call fixtures, lanterns, bridges, routers, network nodes, etc. The networked element 335 may also communicate directly or indirectly with the user devices 331 using one or more communication protocols or standards (e.g., through the network 333).

For example, the networked element 335 may communicate with the user devices 331 using near-field communications (NFC) (e.g., network 333) and thus enable communication between the user devices 331 and the elevator controller 315. In some embodiments, the elevator controller 315 may establish communication with one or more user devices 331 that are outside of the structure/building. Such connection may be established with various technologies including GPS, triangulation, or signal strength detection, by way of non-limiting example. Such technologies that allow communication can provide users and the system(s) described herein more time to perform the described functions. In example embodiments, the user devices 331 communicate with the elevator controller 315 over multiple independent wired and/or wireless networks. Embodiments are intended to cover a wide variety of types of communication between the user devices 331 and the elevator controller 315, and embodiments are not limited to the examples provided in this disclosure.

The network 333 may be any type of known communication network including, but not limited to, a wide area network (WAN), a local area network (LAN), a global network (e.g. Internet), a virtual private network (VPN), a cloud network, and an intranet. The network 333 may be implemented using a wireless network or any kind of physical network implementation known in the art. The user devices 331 and/or the networked devices 335 may be coupled to the elevator controller 315 through multiple networks 333 (e.g., cellular and Internet) so that not all user devices 331 and/or the networked devices 335 are coupled to the elevator controller 315 through the same network 333. One or more of the user devices 331 and the elevator controller 315 may be connected to the network 333 in a wireless fashion. In one non-limiting embodiment, the network 333 is the Internet and one or more of the user devices 331 execute a user interface application (e.g. a web browser) to contact the elevator controller 315 through the network 333.

Embodiments provided herein are direct to apparatuses, systems, and methods for making and fulfilling requests for elevator service. In some embodiments, a request for elevator service may be communicated over one or more lines, connections, or networks, such as network 333, e.g., a request made by a user device 331 and transmitted through the network 333 to the elevator controller 315 to request elevator service. The request for service may be initiated by a mobile device controlled by and/or associated with a user, in a passive or active manner. In some embodiments, the mobile device may be operative in conjunction with a Transmission Control Protocol (TCP) and/or a User Datagram Protocol (UDP). In some embodiments, a request for service may be authenticated or validated based on a location of the user device 331. In some embodiments, a request for service may be fulfilled in accordance with one or more profiles, such as one or more user or mobile device profiles. In some embodiments the profiles may be registered as part of a registration process. In some embodiments, an elevator system 201 may be registered with a service provider.

As noted, the elevator controller 315 may be associated with an elevator system (e.g., elevator systems 101, 201). The elevator controller 315 may be used to process or fulfill the requests for elevator service that are submitted from one or more user devices 331. The requests for elevator service may be received through the network 333 from the one or more user devices 331 and/or the networked building elements 335, which may be mobile devices, including, but not limited to phones, laptops, tablets, smartwatches, etc. One or more of the user devices 331 may be associated with (e.g., owned by) a particular user. The user may use his/her user device(s) 331 to request elevator service.

For example, a user of a user device 331 may request service in an affirmative or active manner. The user may enter a request for elevator service using an I/O interface of the user device 331, as described herein. That is, in some embodiments, an application, app, or other program may be installed and operated on the user device 331 wherein the user may interact with the app or program to request elevator service.

In other embodiments, or in combination therewith, the user may request elevator service in a passive manner. For example, a profile may be established for the user or the particular user device 331, optionally as part of a registration process with, e.g., a service provider and/or through historical data tracking. The profile may contain a log of the user's history and/or activities, such as where the user has gone or traveled to, the user's preferences, or any other data that may be applicable to the user. In some embodiments, the user profile may be accessed or analyzed to determine the likelihood or probability that the user will request elevator service at a particular moment in time (e.g., a particular day or time of day). Resources may be provisioned or allocated to fulfill the request (e.g., an elevator car call or reservation may be placed) in the event that the probability of requested service, or consumption, or use of an elevator is anticipated.

The request for service may be conveyed or transmitted from the user device 331 through the network 333. For example, the request for service may be transmitted to and/or over the Internet and/or a cellular network. The network(s) 333 may include infrastructure that may be organized to facilitate cloud computing. For example, one or more servers, such as a primary message server, a backup message server, and a device commissioning message server may be employed as part of the network 333.

In some embodiments, the request for service may specify a type of service requested, at any level of detail or abstraction. For example, a first request for service may specify that elevator service is requested, a second request for service may specify one or more of a departure floor and/or a destination floor, and a third request for service may specify that elevator service is desired to accommodate a heavy load (e.g., freight or cargo) with a number of other users or passengers in an amount less than a threshold. In some embodiments, the request for service transmitted from the user device 331 may include an identifier associated with the user or the particular user device 331 in order to allow the elevator controller 315 to distinguish between users and/or user devices 331.

Referring now to FIGS. 4A-4B, schematic block diagram illustrations of example computing systems 437a, 437b for a user device 431 and an elevator controller 415, respectively, are shown. The computing system 437a may be representative of computing elements or components of user devices 431, networked elements, mobile devices, etc. as employed in embodiments of the present disclosure. The computing system 437b may be representative of computing elements or components of controllers, elevator controller, networked elements, computers, etc. For example, the computing system 437a can be configured as part of a user device 431, e.g., user device 231, 331 shown above. The computing system 437a can be configured to operate the user device 431, including, but not limited to, operating and controlling a touch-screen display to display various output and receive various input from a user's interaction with the touch-screen display. The computing system 437b can be configured as part of an elevator controller, e.g., elevator controller 115, 215, 315, 415 shown above. The computing system 437b can be a computer or other type of controller that is physically connected or remote from mechanical control of the elevator system 201. The computing system 437b may be connected to various elements and components within a building that are associated with operation of an elevator system 201.

As shown, the computing system 437a includes a memory 439a which may store executable instructions and/or data. The executable instructions may be stored or organized in any manner and at any level of abstraction, such as in connection with one or more applications, apps, programs, processes, routines, procedures, methods, etc. As an example, at least a portion of the instructions are shown in FIG. 4A as being associated with a program 441a. The memory 439a can include RAM and/or ROM and can store the program 441a thereon, wherein the program 441a may be a mobile operating system and/or mobile applications to be used on the user device 431.

Further, the memory 439a may store data 443a. The data 443a may include profile or registration data (e.g., in a user device 431), a device identifier, or any other type(s) of data. The executable instructions stored in the memory 439a may be executed by one or more processors, such as a processor 445a, which may be a mobile processor in the user device 431. The processor 445a may be operative on the data 443a and/or configured to execute the program 441a. In some embodiments, the executable instructions can be performed using a combination of the processor 445a and remote resources (e.g., data and/or programs stored in the cloud (e.g., remote servers)).

The processor 445a may be coupled to one or more input/output (I/O) devices 447a. In some embodiments, the I/O device(s) 447a may include one or more of a physical keyboard or keypad, a touchscreen or touch panel, a display screen, a microphone, a speaker, a mouse, a button, e.g., parts or features of a telephone or mobile device (e.g., a smartphone. For example, the I/O device(s) 447a may be configured to provide an interface to allow a user to interact with the user device 431. In some embodiments, the I/O device(s) 447a may support a graphical user interface (GUI) and/or voice-to-text capabilities for the user device 431.

The components of the computing system 437a may be operably and/or communicably connected by one or more buses. The computing system 437a may further include other features or components as known in the art. For example, the computing system 437a may include one or more communication modules 449a, e.g., transceivers and/or devices configured to receive information or data from sources external to the computing system 437a. In one non-limiting embodiments, the communication modules 449a of the user device 431 can include a near-field communication chip (e.g., Bluetooth®, Wi-Fi, etc.) and a cellular data chip, as known in the art. In some embodiments, the computing system 437a may be configured to receive information over a network (wired or wireless), such as network 333 shown in FIG. 3. The information received over the network may be stored in the memory 439a (e.g., as data 443a) and/or may be processed and/or employed by one or more programs or applications (e.g., program 441a).

The computing systems 437a may be used to execute or perform embodiments and/or processes described herein, such as within and/or on user devices. For example, the computing system 437a of the user device 431 enables a user interface to enable a user to make service requests to an elevator, receive car assignments based on the service request, and observe status of the current assignment as potential secondary assignments, and finally make service requests based on the potential secondary assignment. To make such service requests, the user device 431, and the computing system 437a thereof, may communicate with the computing system 437b of the elevator controller 415.

For example, as shown in FIG. 4B, the elevator controller 415 includes a computing system 437b that is used to receive commands and/or instructions (e.g., data) from remote devices, transmit information, status, and alternatives information to the user device 431. The computing system 437b is configured to control operation of and/or reservation of elevator cars (e.g., 103, 203) within one or more elevator hoistways. The computing system 437b, memory 439b (and program stored thereon) may be configured to process requests for elevator service received from one or more user devices (e.g., user device 431). As part of the processing, the computing system 437b may validate or authenticate the user device 431 such that only certain user devices 431 may be able to communicate and/or make elevator service requests to the elevator controller 415.

As shown, the computing system 437b of the elevator controller 415 includes components similar to that shown and described with respect to the computing system 437a of FIG. 4A. As such, the elevator controller computing system 437b includes a memory 439b with at least one program 441b and data 443b stored thereon. The data 443b may include profile or registration data (e.g., related to user devices), elevator car data, elevator control data and/or programs, or any other type(s) of data associated with control and/or operation of an elevator system. A processor 445b may be configured to receive service requests through a communication module 449b from one or more user devices 431. The computing system 437b may further include one or more I/O devices 447b, including, but not limited to, control connections to one or more elevator mechanical controls and/or elevator cars. Further, in some configurations, the I/O devices 447b can include a monitor or display screen as part of a user interactive computing system that is associated with the elevator system and/or elevator controller 415.

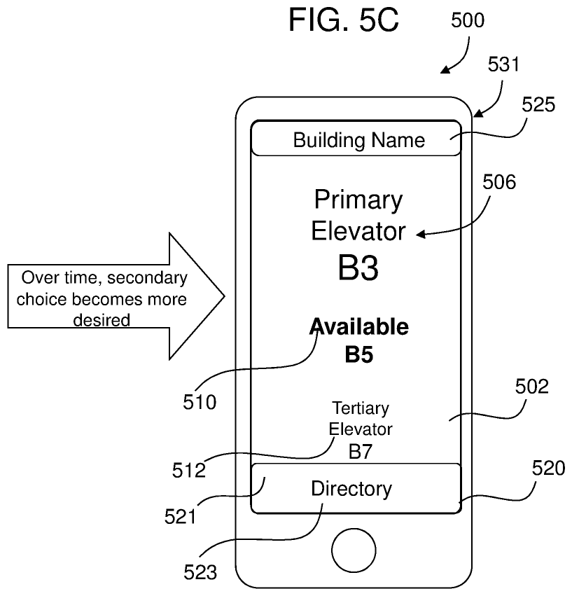

Turning now to FIG. 5A and FIG. 5B, various illustrations of a user interface 500 implemented on a user device 531 (comparable to 231, 331, 431) in accordance with several embodiments of the present disclosure are shown. As shown in FIGS. 5A-5B, a screen 502 of a user device 531 may display the user interface 500 that represents a screen or interface of an application in accordance with an embodiment of the present disclosure. The user interface 500 can enable a user to make elevator service requests, monitor service requests, monitor car assignments, monitor possible alternative car assignments, and select alternatives cars by operation and interaction with the user interface 500 displayed on the screen 502. That is, the user interface 500 can enable a user device 531 to communicate with an elevator controller e.g., 215, 315, 415, to make an elevator service request and numerous other functions in accordance with an embodiment.

In the embodiment shown in FIG. 5A, following a successful destination request for a desired destination or destination floor (not shown) and car assignment (not shown) by the elevator controller e.g., 215, 315, 415, the elevator car 103, 203 assigned by the elevator controller e.g., 215, 315, 415 to satisfy the destination request is sent to the user device 531 and displayed on the screen 502. As depicted, the primary car assignment “B3” 506 is displayed as a graphical object 506 on the screen 502, of the user device 531 and in some embodiments highlighted or bolded for clarity to the user.

In an embodiment, secondarily, the elevator controller e.g., 215, 315, 415 may also determine if there are one or more alternative, secondary, elevator car(s) 103 that may be suitable to the passenger. In some instances, an alternative elevator car 103 may include an elevator car 103 that will arrive in close timing proximity to the first/primary assigned car 103 (e.g., 506), may also be traveling to the same destination floor, or could also be assigned to the same destination floor without overly burdening those passengers already assigned to the secondary car 103. The selection of a particular elevator car 103 as an alternative, secondary assignment may also be displayed on the screen 502 as a graphical object 510 depicting another elevator car 103 e.g. “B5” as a secondary candidate for the user. Moreover, in some instances it may even be possible that that a tertiary candidate car assignment is possible and depicted on the screen 502 as another graphical object 514. The alternative indicates to the user that if desired another potential elevator car 103, 203 assignment may be available. It should be appreciated that in the exemplary embodiments as described herein, one or more potential alternatives elevator car assignments are described. However, such description is merely illustrative, it may be possible that multiple alternatives are available, or in some instances, no alternatives are available as may depend on the particular destination floor requested, departure floor, number of elevator cars 103 available, and the like.

Turning now to FIG. 5B as well, depicting the screen 502 of the user device 531 in accordance with an embodiment. In an embodiment, if the user elects that the secondary assignment elevator “B5” of FIG. 5A is desired, the user may elect to select the graphical object 510 associated the secondary offering by just tapping on the indication for the secondary assignment elevator “B5”. In this instance, as depicted in the FIG. 5B, screen 502 changes to indicate the users selection. In an embodiment, the primary elevator assignment indication and graphical object 506 changes to now indicate that elevator “B5” is assigned. In this instance, as depicted, elevator “B3” (the originally assigned elevator car 103, 203) is now identified as a secondary assignment elevator, while the proposed tertiary assignment elevator remains “B7” as depicted by graphical object 514.

Turning now to FIG. 5C as well, the screen 502 of the user device 531 is shown in accordance with an embodiment. In an embodiment, following the events associated with FIG. 5A and the identification and display of the alternative, secondary, assignment elevator “B5”, if events have transpired such that the alternative secondary assignment elevator car 203 becomes available, (e.g., the primary “B3” is delayed such that the secondary (e.g., B5″ arrives first, or any other events that make the secondary assignment more favorable to the user) the screen 502 and the graphical object 510 (as well as the graphical objects 506 and 514 on the user device 531 may be updated to indicate the updated status. For example, as depicted in the FIG. 5C, indicating that secondary assignment elevator 510, the elevator at “B5” is now “available”. The passenger may elect how to respond. In a first instance, the passenger may elect to ignore the secondary offering, and continue with the primary elevator assignment “B3” as depicted by graphical object 506 as depicted and described previously. Alternatively, in an embodiment, the passenger may now (or in fact, any time following the presentment of the alternative assignment) select the secondary alternative assignment 510 offering of the secondary elevator “B5” by selecting the graphical object 510. Once again, in this instance, as depicted in the FIG. 5B, screen 502 changes to indicate the users selection. In an embodiment, the primary elevator assignment indication of graphical object 506 changes to now indicate that elevator “B5” is assigned. In this instance, as depicted, elevator “B3” (the originally assigned elevator car 103, 203) is now identified as a secondary elevator as depicted by graphical object 510, while the proposed tertiary elevator as depicted by 514 remains “B7”.

In another embodiment, associated with FIG. 5C, presuming events have transpired such that the secondary elevator assignment is desired by the user, the user may simply elect to board the secondary elevator. Upon boarding the secondary assignment elevator car 103, 203 e.g. elevator “B5”, the elevator controller e.g., 215, 315, 415 automatically updates the assignment. In an embodiment, sensing devices (such as Bluetooth sensors, proximity sensors, and the like detect that the user device 231, 331, 431, 531 is in close proximity. This may be accomplished in various ways. In one instance, the user device 231, 331, 431, 531 could execute an app that could detect a Bluetooth signal from a particular transceiver 204 inside the elevator cab and then send a message to the cloud server via communication network 333 indicating it is now inside the secondary elevator car (e.g., 203). This would initiate the cloud server sending a command via the communication network 333 to the elevator system elevator controller 115, 215, 315, 415, 515 to activate a car call (destination floor) in the secondary car (e.g., 203). It should be appreciated, that the reassignment would only be permitted if the alternate elevator car (e.g., 203) that the user entered was already identified by the system and presented on the display screen 502 of the user device 231, 331, 431, 531. Only for the alternate/secondary or tertiary elevators, would this transfer of the destination floor be allowed. Otherwise, the user could be prompted on the user device 231, 331, 431, 531 that they have entered an unassigned elevator car (e.g., 103). The prompt could be a visual or audible warning.

Alternatively, if the user enters a potential alternative assignment elevator car, e.g., 203, the user device 231, 331, 431, 531 could send a signal to a Bluetooth transceiver 204, NFC detector, proximity detector, and the like that is inside the elevator cab of the entered elevator car (e.g., 203). Once again, the communication would only be allowed/addressed in and assigned car, that is, the potential secondary or tertiary elevator car e.g., 203. The elevator system would receive an identifier of this particular user device 231, 331, 431, 531 in the message and cancel that user's originally assigned primary elevator car assignment. In this way, the original primary elevator assignment does not activate a call corresponding to the user's destination floor.

Continuing with FIGS. 5A-5C, in another embodiment, following the events associated with FIG. 5A and the identification and display of the alternative, secondary, assignment elevator “B5”, as depicted by graphical object 510. In an embodiment, as events transpire impacting either the primary assignment elevator car “B3” as depicted by graphical object 506 or the alternative secondary assignment elevator car 203 as depicted by graphical object 510, the graphical objects may change to provide the user a contemporaneous indication of status and the type of change. For example, if the primary assignment elevator car is delayed “B3” is delayed such that the secondary assignment is likely to arrive first, (e.g., elevator B5″ arrives first), the graphical object 506 associated with the primary assignment, and/or the graphical object 510 associated with the secondary assignment may change to indicate the status. For example, if the elevator “B5” associated with the secondary assignment will arrive first, the boldness, size, or color of the graphical object 510 may change, particularly in proportion to graphical object 506 associated with the primary assignment elevator. Conversely, if the secondary assignment become less favorable, then the graphical object associated therewith may shrink or fade. In an embodiment, if any actual assignment or potential assignment becomes unlikely, then the graphical object associated with that assignment may be removed. In this way, the user is presented with a scheme for ascertaining the timing and likelihood that an alternative secondary assignment may become favorable to the users desires.

As shown, the user interface 500 includes additional features, which may be optional. For example, an information region(s) 523, 525 can be located within the user interface 500. As shown, the information region 523 includes directory information, while information region 525 also provides information regarding the current building (e.g., an address) for which the user is using the interface 500 to communicate and/or control the elevator system. In some embodiments, such information region 525 can be static and/or defined by various information obtained by a user device 531 (such as GPS, Wi-Fi location, etc.). In other embodiments, the information region 525 can be an interactive tab or other interactive feature that can enable a user to make selections, change displayed information, change the building selection to another building, etc. Although shown at the top and bottom of the user interface 500, the information region 525 can be located at any position on the user interface 500 and/or can take various geometric forms, colors, etc.

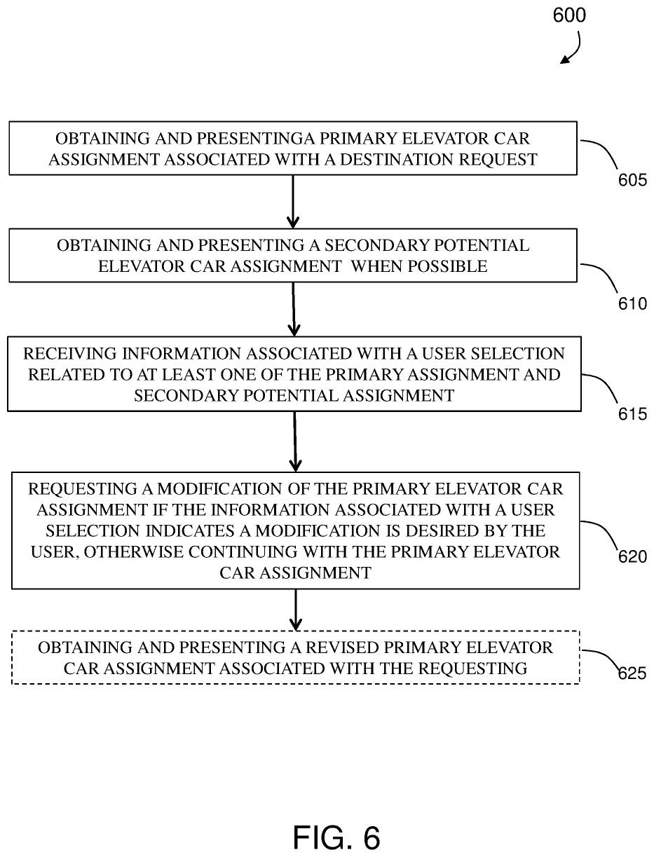

Turning now to FIG. 6, a flow process 600 in accordance with an embodiment of the present disclosure is shown. Flow process 600 may incorporate additional or alternative steps without departing from the scope of the present disclosure. The flow process 600 may be performed by a processor on a user device (e.g., 231, 331, 431, 531 as described above) with various related applications and/or data stored in a memory of the user device 231, 331, 431, 531.

At process step 605, the user device (e.g., 231, 331, 431, 531) obtains and presents a primary elevator car assignment associated with a user's destination request. Moreover, at process step 610 the user device (e.g., 231, 331, 431, 531) obtains and presents a secondary elevator car assignment associated with a user's destination request. The assignment(s) are provided by the elevator controller (e.g., 215, 315, 415) defining an optimal elevator car assignment based on the operation of the elevators in the building and the destination request(s) currently being serviced. As explained herein, in many instances more than one elevator car 103, 203 may be a potential candidate for the assignment. As such, the secondary elevator assignment is also provided as a potential option as described herein. The method 600 continues at process step 615 with the user device (e.g., 231, 331, 431, 531) receiving information associated with a user's selection related to at least one of the primary elevator car assignment and the secondary potential assignment. The information could include, but not be limited to, a selection of the secondary assignment, an action by the user that can be inferred as a selection of the secondary potential assignment (e.g., entering the elevator car of the secondary assignment, or an action by the user that can be inferred as concurrence with the primary assignment (e.g., for example, taking no action but entering the assigned elevator car.

Continuing with the method 600, at process step 620 if the information received is indicative of a selection by the user of the secondary elevator car assignment, for example selection of the graphical object 510 associated with the secondary elevator car assignment the user device (e.g., 231, 331, 431, 531) requests a modification of the primary elevator car assignment (e.g., depicted by graphical object 506) based on the selection. The elevator controller (e.g., 215, 315, 415) modifies the destination dispatching and changes the assignment for that user's request to the selected secondary elevator car 103, 203. If no selection or other user input (such as entering the secondary car) is noted, the system continues it the initial primary elevator car assignment. Moreover, in an embodiment, optionally at process step 625, if the user makes a selection on the user device (e.g., 231, 331, 431, 531), a revised primary elevator car assignment associated with the user selection may be displayed on the user device (e.g., 231, 331, 431, 531).

As described herein, in some embodiments various functions or acts may take place at a given location and/or in connection with the operation of one or more apparatuses, systems, or devices. For example, in some embodiments, a portion of a given function or act may be performed at a first device or location (e.g., user device 531), and the remainder of the function or act may be performed at one or more additional devices or locations (e.g., elevator controller). Further, embodiments described herein may be implemented using one or more technologies. In some embodiments, an apparatus or system may include one or more processors and memory storing instructions that, when executed by the one or more processors, cause the apparatus or system to perform one or more methodological acts as described herein. Various mechanical components known to those of skill in the art may be employed without departing from the scope of the present disclosure.

Embodiments may be implemented as one or more apparatuses, systems, and/or methods. In some embodiments, instructions may be stored on one or more computer program products or computer-readable media, such as a transitory and/or non-transitory computer-readable medium. The instructions, when executed, may cause an entity (e.g., an apparatus or system) to perform one or more methodological acts as described herein.

Aspects of the disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional.

The use of the terms “a”, “an”, “the”, and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

What is claimed is:

1. A method for providing and selecting multiple elevator assignments in a building having an elevator system with a destination dispatching system, the method comprising:
obtaining and presenting, by a user device, a primary elevator car assignment associated with a destination request;
obtaining and presenting, by a user device, a secondary potential elevator car assignment associated with the destination request;
receiving, by a user device, information associated with a user selection related to at least one of the primary elevator car assignment and secondary potential elevator car assignment; and
requesting, by the user device, a modification of the primary elevator car assignment if the information associated with a user selection indicates a modification is desired by the user; otherwise, continuing with the primary elevator car assignment.

2. The method of claim 1, wherein the primary elevator car assignment is the first, most optimal, elevator car assignment by the destination dispatching system.

3. The method of claim 1, wherein the user device includes a graphical object associated with the primary elevator car assignment and a graphical object associated with the secondary potential elevator car assignment.

4. The method of claim 3, wherein the receiving information includes a selection of at least one of the graphical object associated with primary elevator car assignment, the graphical object associated with the secondary potential elevator car assignment, and a user action.

5. The method of claim 4, wherein the user action includes at least one of the user entering the elevator car associated with the primary elevator car assignment and the user entering the elevator car associated with the secondary potential elevator car assignment.

6. The method of claim 5, wherein the receiving further includes at least one of:
detecting a presence of the user device in at least one of the elevator car associated with the primary elevator car assignment and the user device entering the elevator car associated with the secondary potential elevator car assignment, the detecting based on communicating from the user device to at least one of the elevator car associated with the primary elevator car assignment and the elevator car associated with the secondary potential elevator car assignment; and
communicating to the user device in at least one of the elevator car associated with the primary elevator car assignment and the user device entering the elevator car associated with the secondary potential elevator car assignment, the communicating associated with indicating to the user device that the user has entered the at least one of the elevator car associated with the primary elevator car assignment and the elevator car associated with the secondary potential elevator car assignment.

7. The method of claim 1, wherein the requesting a modification includes communicating by the user device a request to modify the primary elevator car assignment to an elevator controller.

8. The method of claim 1, wherein:
presenting, by a user device, a primary elevator car assignment includes displaying a graphical object associated with the primary elevator car assignment; and
presenting, by a user device, a secondary potential elevator car assignment includes displaying a graphical object associated with the second elevator car assignment; and
presenting, by a user device, a revised primary elevator car assignment associated with the requesting includes displaying a graphical object associated with the revised primary elevator car assignment.

9. The method of claim 8, wherein the displaying the graphical object associated with the primary elevator car assignment includes at least one of a displaying the graphical icon as at least one of larger, bolder, highlighted, in a different color, and flashing when compared to the graphical icon associated with the secondary potential elevator car assignment.

10. The method of claim 8, wherein the displaying the graphical object associated with the revised primary elevator car assignment includes at least one of a displaying the graphical icon as at least one of larger, bolder, highlighted, in a different color, and flashing when compared to the graphical icon associated with the secondary potential elevator car assignment.

11. The method of claim 8, wherein the displaying the graphical object associated with the secondary potential elevator car assignment includes at least one of a displaying the graphical icon as at least one of smaller, lighter, shadowed, in a different color, and changing when compared to the graphical icon associated with the primary elevator car assignment.

12. The method of claim 11, wherein the changing includes at least one of changing size, changing shape, changing boldness, changing color.

13. The method of claim 11, wherein the changing is based on the favorability of the secondary potential elevator car assignment to the user.

14. The method of claim 13, wherein the favorability to the user is based at least in part on arrival time of the elevator car associated with the secondary potential elevator car assignment.

15. The method of claim 13, obtaining and presenting, by a user device, a revised primary elevator car assignment associated with the requesting.

16. A user device for making elevator service requests, the user device comprising:
at least one processor;
a display; and
memory having instructions stored thereon that, when executed by the at least one processor, cause the user device to:
obtain and present a primary elevator car assignment associated with a destination request;
obtain and present a secondary potential elevator car assignment associated with the destination request;
receive information associated with a user selection related to at least one of the primary elevator car assignment and secondary potential elevator car assignment; and
request a modification of the primary elevator car assignment if the information associated with a user selection indicates a modification is desired by the user; otherwise, continuing with the primary elevator car assignment.

17. The user device of claim 16, wherein the primary elevator car assignment is the first, most optimal, elevator car assignment by the destination dispatching system.

18. The user device of claim 16, wherein the user device includes a screen with a graphical object associated with the primary elevator car assignment and a graphical object associated with the secondary potential elevator car assignment.

19. The user device of claim 16, wherein the receiving information includes a selection of at least one of the graphical object associated with primary elevator car assignment, the graphical object associated with the secondary potential elevator car assignment, and a user action.

20. The user device of claim 19, wherein the user action includes at least one of the user entering the elevator car associated with the primary elevator car assignment and the user entering the elevator car associated with the secondary potential elevator car assignment.
